(19) United States
(12) Patent Application Publication
(10) Pub. No.: US 2025/0350369 A1
(43) Pub. Date: Nov. 13, 2025

(54) OPTICAL RECEIVER AND OPTICAL RECEIVING METHOD

(71) Applicant: Fujitsu Limited, Kawasaki-shi (JP)

(72) Inventor: TOMOHIRO NAGANUMA, Kawasaki (JP)

(73) Assignee: Fujitsu Limited, Kawasaki-shi (JP)

(21) Appl. No.: 19/201,181

(22) Filed: May 7, 2025

(30) Foreign Application Priority Data
May 13, 2024 (JP) 2024-077907

(51) Int. Cl. H04B 10/61

(52) U.S. Cl. CPC H04B 10/6162

(57) ABSTRACT

An optical receiver includes a receiver to receive an optical signal, a convertor to convert an electrical analog signal into a digital signal, a first compensator to fixedly compensate for a first signal distortion of the digital signal based on a first tap coefficient, a second compensator to adaptively compensate for a second distortion of the digital signal that has been compensated by the first compensator, based on a second tap coefficient with a second tap stage number different from a first tap stage number of the first compensator, and a controller to acquire the digital signal output from the first compensator before being input to the second compensator, calculate a third tap coefficient that adaptively compensates for the second signal distortion with the first tap stage number, and update the first tap coefficient of the first compensator based on the first tap coefficient and the third tap coefficient.

### CROSS-REFERENCE TO RELATED APPLICATION

This application is based upon and claims the benefit of priority of the prior Japanese Patent Application No. 2024-077907, filed on May 13, 2024, the entire contents of which are incorporated herein by reference.

### FIELD

A certain aspect of embodiments described herein relates to an optical receiver and an optical receiving method.

### BACKGROUND

Coherent optical communication and coherent optical receivers are known (see, for example, Japanese Patent Application Publication No. 2023-506565, US Patent Application Publication No. 2022/0393772, and International Publication No. 2017/091393). In coherent optical communication, distortion of a transmission signal is compensated for by digital signal processing at the receiving end. In digital signal processing, mainly processes such as chromatic dispersion compensation, frequency control/phase adjustment, polarization multiplexing/demultiplexing, or polarization dispersion compensation is performed. The polarization multiplexing/demultiplexing and polarization dispersion compensation processes are mainly performed by adaptive equalization.

Digital filters are generally used for adaptive equalizers in digital signal processing. The adaptive equalizer can compensate for the transmission signal by setting tap coefficients in the digital filters that are calculated to offset the distortion of the transmission signal. The tap coefficients are updated sequentially to adapt to the time-varying situation. In this way, the adaptive equalizer performs compensation that tracks the fluctuations in the polarization state (see, for example, Japanese Patent Application Publication No. 2021-190787).

### SUMMARY

According to an aspect of the present invention, there is provided an optical receiver including: a receiver configured to receive an optical signal that is input via an optical transmission path; a convertor configured to convert an electrical analog signal according to the optical signal into a digital signal; a first compensator configured to fixedly compensate for a first signal distortion of the digital signal based on a first tap coefficient; a second compensator configured to adaptively compensate for a second distortion of the digital signal that has been compensated by the first compensator, based on a second tap coefficient with a second tap stage number different from a first tap stage number of the first compensator; and a controller configured to acquire the digital signal output from the first compensator before being input to the second compensator, calculate a third tap coefficient that adaptively compensates for the second signal distortion with the first tap stage number, and update the first tap coefficient of the first compensator based on the first tap coefficient and the third tap coefficient.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 illustrates an optical transmission system;

FIG. 2 illustrates a hardware configuration of an optical receiver;

FIG. 3 illustrates a functional configuration of a RxDSP and a reception controller;

FIG. 4 illustrates a flowchart of an operation of a reception controller; and

FIG. 5 illustrates a graph for describing effect of an optical transmission system.

### DESCRIPTION OF EMBODIMENTS

Incidentally, it is desirable to have a small number of tap stages in the digital filter used in the adaptive equalizer described above, from the viewpoint of ensuring the characteristic of tracking the fluctuations in the polarization state. For example, if the number of tap stages is reduced, not only is the characteristic of tracking the fluctuations in the polarization state ensured, but the power consumed by the adaptive equalizer may also be reduced.

However, reducing the number of tap stages may lead to a decrease in the compensation accuracy in the adaptive equalizer. If the compensation accuracy decreases, the distortion of the transmission signal (hereinafter referred to as signal distortion) will not be sufficiently compensated, and there is a risk of signal errors occurring in the transmission signal. However, if the number of tap stages of the digital filter used in the adaptive equalizer is increased from the viewpoint of improving the compensation accuracy, another problem occurs in that the power consumed by the adaptive equalizer increases.

Below, an embodiment will be explained with reference to the drawings.

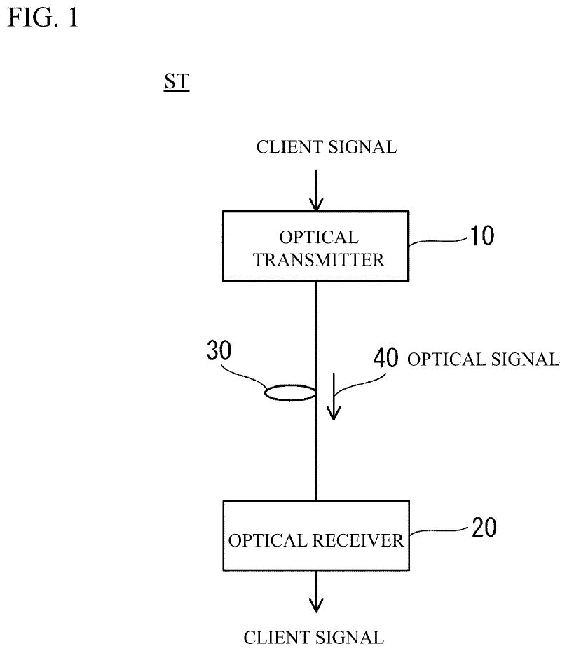

As illustrated in FIG. 1, an optical transmission system ST includes an optical transmitter 10 and an optical receiver 20. The optical transmitter 10 and the optical receiver 20 are connected via an optical transmission path 30. The optical transmission path 30 includes, for example, an optical fiber and an optical repeater. An example of optical repeater is such as a ROADM (Reconfigurable Optical Add/Drop Multiplexer), an ILA (In-Line Amplifier) or the like. The optical transmitter 10 receives an electrical client signal in a digital format from a client network.

The client signal is, for example, an Ethernet (registered trademark) signal. The client signal may be a main signal or a control signal that includes only parameters for adjusting transmission characteristics, or the like. The optical transmitter 10 converts the client signal into an optical signal 40 and transmits the optical signal 40 to the optical transmission path 30. As a result, the optical signal 40 propagates through the optical transmission path 30. The optical receiver 20 receives the optical signal 40 from the optical transmission path 30. When the optical receiver 20 receives the optical signal 40, the optical receiver 20 converts the optical signal 40 into a client signal and transmits the optical signal 40 to the client network.

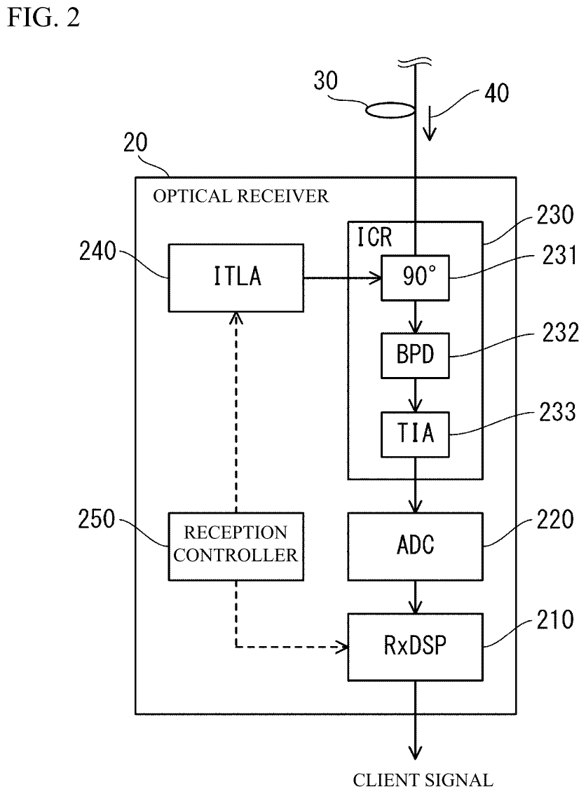

Next, the hardware configuration of the optical receiver 20 will be described with reference to FIG. 2.

As illustrated in FIG. 2, the optical receiver 20 has an RxDSP (Rx Digital Signal Processor) 210, an ADC (Analogue to Digital Converter) 220, and an ICR (Integrated Coherent Receiver) 230. The optical receiver 20 also has an ITLA (Integrable Tunable Laser Assembly) 240, and a reception controller 250. The RxDSP 210 is a DSP mounted on the optical receiver 20. The reception controller 250 is provided independently of the RxDSP 210.

The ICR 230 includes a 90° optical hybrid circuit (simply indicated as 90° in FIG. 2) 231, a BPD (Balanced Photo Diode) 232, and a TIA (Transimpedance Amplifier) 233. The ICR 230 is an integrated circuit that houses the 90° optical hybrid circuit 231, the BPD 232, and the TIA 233 in a single package. The ICR 230 or the 90° optical hybrid circuit 231 is an example of a receiver. Although not illustrated, the ITLA 240 includes a local light source that outputs local light (specifically, laser light).

The optical signal 40 transmitted from the optical transmitter 10 and propagated through the optical transmission path 30 is input to the 90° optical hybrid circuit 231. The 90° optical hybrid circuit 231 receives the optical signal 40 by the local light output from the ITLA 240, and outputs the optical signal 40 to the BPD 232.

The BPD 232 converts the optical signal 40 to a current signal and outputs the current signal to the TIA 233. The TIA 233 converts the current signal output from the BPD 232 to a voltage signal, and amplifies the voltage signal to an amplitude suitable for the ADC 220, and outputs the amplified voltage signal to the ADC 220 as an electrical analog signal.

In this way, the ICR 230 receives the input optical signal 40 and converts the optical signal 40 to an analog signal using the 90° optical hybrid circuit 231, the BPD 232, and the TIA 233. The ADC 220 is an example of a convertor, and converts the analog signal to a digital signal and outputs the digital signal to the RxDSP 210. The RxDSP 210 receives the digital signal output from the ADC 220 based on a baud rate set by the reception controller 250.

The RxDSP 210 is an example of a processor, and executes various digital signal processing. For example, the RxDSP 210 performs symbol de-mapping processing on the data symbols included in the digital signal based on the baud rate and multi-level modulation method set by the reception controller 250. Specifically, the RxDSP 210 converts the data symbols into a binary data bit string. The RxDSP 210 then reproduces a transfer frame corresponding to the binary data bit string. The transfer frame includes, for example, an OTU (Optical channel Transport Unit) frame. After reproducing the transfer frame, the RxDSP 210 extracts the client signal from the transfer frame and transmits the extracted client signal to the client network. The digital signal processing executed by the RxDSP 210 will be described in detail later.

The reception controller 250 includes a processor and a memory, and controls the operations of the RxDSP 210 and the ITLA 240. The processor includes, for example, a CPU (Central Processing Unit). The memory includes volatile memory such as RAM (Random Access Memory) and non-volatile memory such as ROM (Read

Only Memory). The reception controller 250 may be an FPGA (Field Programmable Gate Array) or an ASIC (Application Specific Integrated Circuit).

The reception controller 250 performs various settings on the RxDSP 210 according to instructions from the operation terminal, and adjusts the frequency of the ITLA 240. The operation terminal may be a PC (Personal Computer) or a smart terminal (such as a tablet terminal). For example, when a signal type including a baud rate and a multi-level modulation method is input from the operation terminal to the reception controller 250, the reception controller 250 sets the baud rate and the multi-level modulation method in the RxDSP 210.

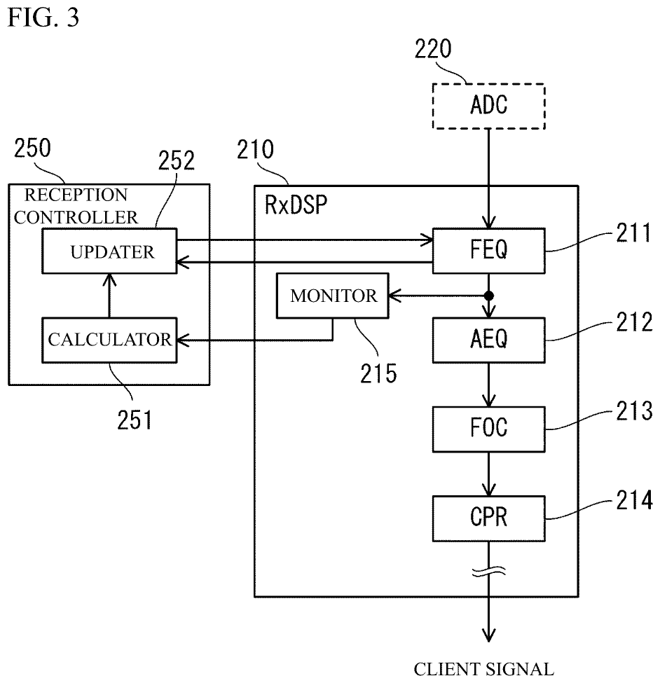

Next, the functional configuration of the RxDSP 210 and the reception controller 250 will be described with reference to FIG. 3.

First, the functional configuration of the RxDSP 210 will be described. The RxDSP 210 includes a FEQ (Fixed Equalizer) 211 and an AEQ (Adaptive Equalizer) 212. The RxDSP 210 also includes an FOC (Frequency Offset Compensation) 213, a CPR (Carrier Phase Recovery) 214, and a monitor 215. Although not illustrated, the RxDSP 210 includes a demodulator that performs symbol de-mapping processing after the CPR 214 and processes to output a client signal.

The FEQ 211 is an example of a first compensator, and compensates for signal distortion generated in the optical transmitter 10, the optical receiver 20, and the optical transmission path 30 in a fixed manner for the digital signal output from the ADC 220. Specifically, the FEQ 211 performs chromatic dispersion compensation, skew compensation, and bandwidth characteristic compensation for analog devices such as the ADC 220. An AEQ 212 is an example of a second compensator, and adaptively compensates for signal distortion of the optical signal 40 caused by polarization mode dispersion and polarization dependent loss occurring on the optical transmission path 30 for the digital signal output from the FEQ 211.

The FOC 213 estimates an optical frequency offset for the digital signal output from the AEQ 212, and compensates for the estimated optical frequency offset. The optical frequency offset is the difference between the frequency of the transmission light output by ITLA (not illustrated of the optical transmitter 10 and the frequency of the local light output by the ITLA 240 of the optical receiver 20. The CPR 214 compensates for phase noise of the ITLA 240 and fluctuation components of high-speed residual frequency offset that could not be fully compensated for by the FOC 213. The monitor 215 is an example of a transferer, and when the optical receiver 20 is started up, the monitor 215 monitors the digital signal output from the FEQ 211 and before being input to the AEQ 212, and transfers the digital signal to the reception controller 250.

Here, both the FEQ 211 and the AEQ 212 are realized by a FIR (Finite Impulse Response) filter. The FIR filter is a type of a digital filter. More specifically, the FEQ 211 is realized by an FIR filter including a fractionally spaced filter, and the AEQ 212 is realized by an FIR filter including a butterfly filter. However, the first tap number, which is the number of tap stages of the FIR filter that realizes the FEQ211, is different from the second tap number, which is the number of tap stages of the FIR filter that realizes the AEQ 212.

For example, the second tap number is less than the first tap number. As a result, the FEQ 211 compensates for most of the signal distortion, such as chromatic dispersion and skew, as the first signal distortion, and the AEQ 212 compensates for the signal distortion remaining in the digital signal after compensation by the FEQ 211 as the second signal distortion.

Furthermore, the FEQ 211 compensates for most of the signal distortion based on a tap coefficient (hereinafter referred to as the first tap coefficient) set in the FEQ 211 itself before the optical receiver 20 is started. The first tap coefficient is determined, for example, based on a prior experiment or design. On the other hand, the AEQ 212 calculates a tap coefficient (hereinafter referred to as the second tap coefficient) to be set in the AEQ 212 itself based on a predetermined control method, for example, the CMA (Constant Modulus Algorithm) method or the DD-LMS (Decision Directed Least Mean Square) method. After calculating the second tap coefficient, the AEQ 212 compensates for the remaining signal distortion based on the calculated second tap coefficient.

During the manufacturing stage of the optical receiver 20, the optical receiver 20 is manufactured within a specific environmental temperature range that is adjusted in advance indoors or in a field, so that the first tap coefficient can be determined in advance. However, during the operation of the optical receiver 20, the optical receiver 20 may be operated outside a specific environmental temperature range. In this case, there is a possibility that the FEQ 211 will not be able to fully compensate for the signal distortion. For this reason, the AEQ 212 adaptively compensates for the signal distortion that the FEQ211 cannot fully compensate for, based on the second tap coefficient.

In this way, the roles of the FEQ 211 and the AEQ 212 are different. That is, the FEQ 211 compensates for the signal distortion contained in the digital signal in a fixed manner, based on the first tap coefficient. On the other hand, the AEQ 212 adaptively compensates for the signal distortion that the FEQ 211 cannot fully compensate for, for example, due to fluctuations in the environmental temperature, based on the second tap coefficient.

Next, the reception controller 250 will be described. First, the reception controller 250 includes a calculator 251 and an updater 252. The calculator 251 acquires the digital signal transferred from the monitor 215 when the optical receiver 20 is started. When the calculator 251 acquires the digital signal, the calculator 251 calculates the third tap coefficient based on the digital signal.

Here, the calculator 251 is realized by a butterfly filter with a greater number of tap stages than the butterfly filter that realizes the AEQ 212 described above. For example, the calculator 251 is realized by a butterfly filter with the first tap stage that is greater than the second tap stage. In other words, the calculator 251 is realized by a virtual AEQ (not illustrated) in which the tap stage (that is, the first tap stage) of the fractionally spaced filter that realizes the FEQ 211 is applied to the butterfly filter that realizes the AEQ 212.

As a result, the calculator 251 can calculate a third tap coefficient different from both the first tap coefficient and the second tap coefficient based on the digital signal and the virtual AEQ to which the first tap stage is applied. After the calculator 251 calculates the third tap coefficient, the calculator 251 outputs the third tap coefficient to the updater 252.

The updater 252 acquires the third tap coefficient calculated by the calculator 251. After acquiring the third tap coefficient, the updater 252 acquires the first tap coefficient set in the FEQ 211 itself from the FEQ 211. After acquiring the first tap coefficient, the updater 252 updates the first tap coefficient of the FEQ 211 based on the first tap coefficient and the third tap coefficient.

More specifically, the updater 252 generates a fourth tap coefficient based on the first tap coefficient, the third tap coefficient, and a convolution operation, and updates the first tap coefficient of the FEQ 211 based on the fourth tap coefficient. For example, the updater 252 can update the first tap coefficient to the fourth tap coefficient. That is, the updater 252 can replace the first tap coefficient with the fourth tap coefficient. This allows the updater 252 to reset the first tap coefficient set in the FEQ 211 during shipping test adjustment to the fourth tap coefficient when the optical receiver 20 is started up. Therefore, during operation of the optical transmission system ST, the FEQ 211 compensates for the signal distortion in a fixed manner based on the fourth tap coefficient.

The convolution operation can be expressed by the following formula. In the formula, X[n] represents the fourth tap coefficient, h[n] represents the third tap coefficient, and x[n] represents the first tap coefficient. M represents the first tap stage, n represents the tap number in X[n], h[n], and x[n], and m represents the tap number in h[m].

$$X [ n ] = h [ n ] * x [ n ] = {\sum }_{m = 0}^{M} h [ m ] x [ n - m ] \qquad [ Formula 1 ]$$

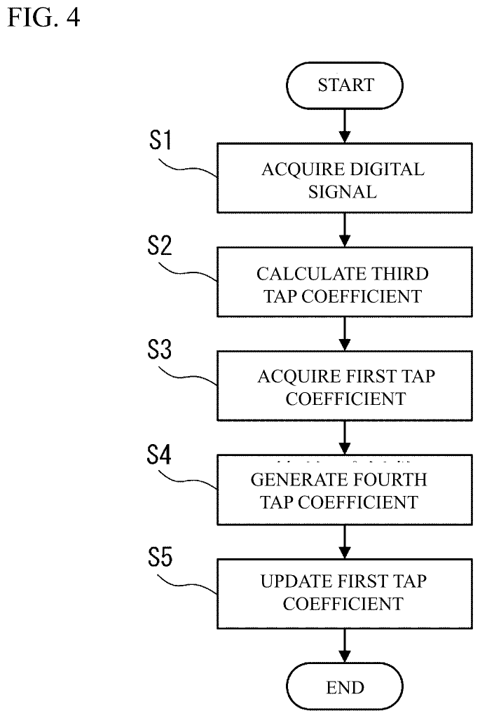

Next, the operation of the reception controller 250 will be described with reference to FIG. 4.

First, the calculator 251 acquires a digital signal (step S1). More specifically, the calculator 251 acquires a digital signal transferred from the monitor 215. There is a possibility that the digital signal acquired by the calculator 251 may contain signal distortion that could not be fully compensated for by the FEQ 211.

After acquiring the digital signal, the calculator 251 then calculates the third tap coefficient (step S2). More specifically, as described above, the calculator 251 calculates the third tap coefficient based on the digital signal and the virtual AEQ to which the first tap stage number is applied.

After calculating the third tap coefficient, the updater 252 then acquires the first tap coefficient (step S3). More specifically, the updater 252 accesses the FEQ 211 and acquires from the FEQ 211 the first tap coefficient set in the FEQ 211 itself. Upon acquiring the first tap coefficient, the updater 252 generates the fourth tap coefficient (step S4). As described above, the updater 252 generates the fourth tap coefficient based on the third tap coefficient output from the calculator 251, the first tap coefficient, and the convolution operation.

When the fourth tap coefficient is generated, the updater 252 updates the first

tap coefficient (step S5) and ends the process. More specifically, as described above, the updater 252 updates the first tap coefficient of the FEQ 211 based on the fourth tap coefficient and ends the process.

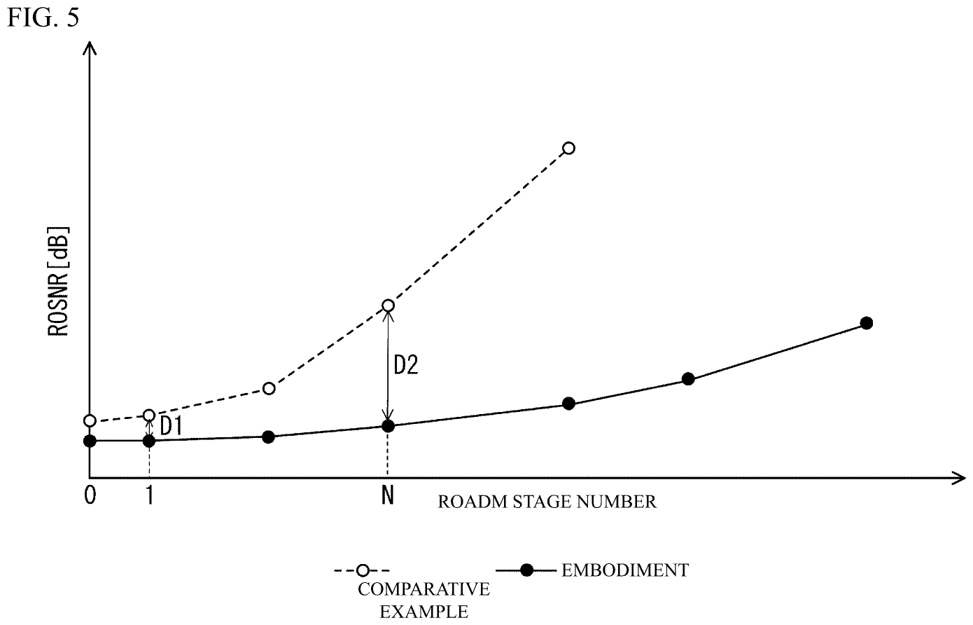

Next, the effect of the optical transmission system ST including the optical receiver 20 will be described with reference to FIG. 5.

When the optical transmission system ST is operated, the above-mentioned optical transmission path 30 often includes a ROADM as an optical repeater. In FIG. 5, the relationship between the number of ROADM stages included in the optical transmission path 30 and the ROSNR (Required Optical Signal to Noise Ratio) is illustrated for a comparative example and an embodiment. The number of ROADM stages may be one or N. N is a natural number equal to or greater than 2. ROSNR represents the limit value of the optical signal-to-noise ratio at which error-free transmission without bit errors can be achieved when the optical receiver 20 receives the optical signal 40 transmitted from the optical transmitter 10.

Here, the optical signal-to-noise ratio is defined as the ratio of the signal component to the noise component in the optical signal 40. The smaller the optical signal-to-noise ratio is, the greater the amount of noise component superimposed on the optical signal 40 is. The longer the transmission distance of the optical signal 40 is, the greater the amount of noise superimposed on the optical signal 40 is. In other words, the optical signal-to-noise ratio decreases. Therefore, the larger the ROSNR is, the smaller the amount of noise component that can be tolerated in the transmission of the optical signal 40 is. In other words, the smaller the ROSNR is, the greater the amount of noise component that can be tolerated in the transmission of the optical signal 40 is.

When the optical transmission path 30 includes a ROADM, the optical filter installed in the ROADM narrows the transmission band for the optical signal 40. Due to the narrowing of the transmission band, noise components are superimposed on the optical signal 40. Therefore, the narrowing of the transmission band becomes a factor limiting the transmission distance of the optical signal 40. Since the narrowing of the transmission band occurs for each ROADM, the amount of noise components superimposed on the optical signal 40 increases as the number of ROADM stages included in the optical transmission path 30 increases. Therefore, the optical signal 40 received by the optical receiver 20 contains a large amount of noise components.

As illustrated in FIG. 5, in both the embodiment and the comparative example, the ROSNR increases with an increase in the number of ROADM stages. However, the rate at which the ROSNR increases differs between the embodiment and the comparative example. For example, in the comparative example, the ROSNR increases more rapidly as the number of ROADM stages increases. On the other hand, in the embodiment, the ROSNR increases as the number of ROADM stages increases, but the

ROSNR does not increase as rapidly as in the comparative example, but increases slowly. For example, when the number of ROADM stages is N, the difference D2 in the ROSNR between the comparative example and the embodiment is more than twice (specifically, nearly four times) the difference D1 when the number of ROADM stages is one.

In this way, even if the number of ROADM stages increases, the increase in the ROSNR in the embodiment is suppressed if the increase in the ROSNR in the comparative example is used as a reference. That is, the optical transmission system ST includes the optical receiver 20, thereby improving the compensation for the optical transmission path 30. As a result, the optical transmission system ST can include

ROADMs with many stages. As a result, the optical transmission system ST can extend the transmission distance of the optical signal 40.

As described above, the RxDSP 210 according to this embodiment includes the monitor 215 that transfers the digital signal output from the FEQ 211 and before being input to the AEQ 212 to the reception controller 250. In addition, the reception controller 250 according to this embodiment includes the calculator 251 and the updater 252. The calculator 251 calculates the third tap coefficient based on the butterfly filter with the first tap stage and the digital signal. The updater 252 updates the first tap coefficient based on the third tap coefficient and the first tap coefficient set in the FEQ 211.

As a result, it is possible to accurately compensate for signal distortion without increasing the number of tap stages of the AEQ 212. In this way, the RxDSP 210 and the reception controller 250 of this embodiment work together to accurately compensate for signal distortion, thereby improving the tolerance of the optical signal-to-noise ratio.

Furthermore, by providing the reception controller 250 independently of the RxDSP 210, which includes the FEQ 211 and the AEQ 212, the processing load on the RxDSP 210 can be reduced. This makes it possible to reduce the electrical power consumption of the RxDSP 210 compared to when the RxDSP 210 includes the calculator 251 and the updater 252.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. An optical receiver comprising:
a receiver configured to receive an optical signal that is input via an optical transmission path;
a convertor configured to convert an electrical analog signal according to the optical signal into a digital signal;
a first compensator configured to fixedly compensate for a first signal distortion of the digital signal based on a first tap coefficient;
a second compensator configured to adaptively compensate for a second distortion of the digital signal that has been compensated by the first compensator, based on a second tap coefficient with a second tap stage number different from a first tap stage number of the first compensator; and
a controller configured to acquire the digital signal output from the first compensator before being input to the second compensator, calculate a third tap coefficient that adaptively compensates for the second signal distortion with the first tap stage number, and update the first tap coefficient of the first compensator based on the first tap coefficient and the third tap coefficient.

2. The optical receiver as claimed in claim 1,
wherein the controller is provided independently from a processor including the first compensator and the second compensator.

3. The optical receiver as claimed in claim 2,
wherein the processor includes a transferer configured to acquire the digital signal output from the first compensator and before being input to the second compensator, and transfers the digital signal to the controller.

4. The optical receiver as claimed in claim 1,
wherein the controller generates a fourth tap coefficient based on the first tap coefficient, the third tap coefficient, and a convolution operation, and updates the first tap coefficient of the first compensator based on the fourth tap coefficient.

5. The optical receiver as claimed in claim 1,
wherein the controller generates a fourth tap coefficient based on the first tap coefficient, the third tap coefficient, and a convolution operation, updates the first tap coefficient of the first compensator to the fourth tap coefficient, and
wherein the first compensator fixedly compensates for the first signal distortion based on the fourth tap coefficient.

6. The optical receiver as claimed in claim 1,
wherein the first compensator is a first FIR (Finite Impulse Response) filter including a fractionally spaced filter, and
wherein the second compensator is a second FIR filter including a butterfly type filter.

7. An optical receiving method comprising:
receiving an optical signal that is input via an optical transmission path;
converting an electrical analog signal according to the optical signal into a digital signal;
fixedly compensating for a first signal distortion of the digital signal based on a first tap coefficient;
adaptively compensating for a second signal distortion of the digital signal after the first distortion is compensated for, based on a second tap coefficient with a second tap stage number different from a first tap stage number of a first compensator for compensating for the first signal distortion;
acquiring the digital signal after the first signal distortion has been compensated for and before the second signal distortion has been compensated for;
calculating a third tap coefficient that adaptively compensates for the second signal distortion with the first tap stage number; and
updating the first tap coefficient when compensating for the first signal distortion based on the first tap coefficient and the third tap coefficient.
